(19) United States
(12) Patent Application Publication
(10) Pub. No.: US 2026/0094926 A1
(43) Pub. Date: Apr. 2, 2026

(54) SOLID-STATE BATTERY

(71) Applicant: TOYOTA JIDOSHA KABUSHIKI KAISHA, Toyota-shi (JP)

(72) Inventors: Ryo ASAKURA, Sunto-gun (JP); Shinya SHIOTANI, Nagoya-shi (JP); Sadao FUJISAKI, Hadano-shi (JP); Hiroo NOZAKI, Toyota-shi (JP)

(73) Assignee: TOYOTA JIDOSHA KABUSHIKI KAISHA, Toyota-shi (JP)

(21) Appl. No.: 19/274,825

(22) Filed: Jul. 21, 2025

(30) Foreign Application Priority Data
Oct. 2, 2024 (JP) 2024-173896

(51) Int. Cl. H01M 50/293; H01M 10/0585

(52) U.S. Cl. CPC H01M 50/293; H01M 10/0585; H01M 2220/20

(57) ABSTRACT

A solid-state battery includes: a laminated body in which a positive electrode current collector, a positive electrode active material layer, a solid electrolyte layer, a negative electrode active material layer, and a negative electrode current collector are laminated in this order; an outer package body that houses the laminated body in the interior; and a block body, in which: the Young's modulus of at least a portion of the block body is 50 GPa or higher, the portion of the block body contacting with a side surface of the positive electrode active material layer and/or a side surface of the negative electrode active material layer; and both ends of the block body are away from the positive electrode current collector and the negative electrode current collector, in a lamination direction of the laminated body.

### CROSS-REFERENCE TO RELATED APPLICATION

This application claims priority to Japanese Patent Application No. 2024-173896 filed on Oct. 2, 2024. The disclosure of the above-identified application, including the specification, drawings, and claims, is incorporated by reference herein in its entirety.

### BACKGROUND

### 1. Technical Field

The present disclosure relates to a solid-state battery.

### 2. Description of Related Art

A secondary battery in which the circumference of a battery element is coated with resin and a secondary battery in which a spacer contacting with a battery element is disposed are known. For example, Japanese Unexamined Patent Application Publication No. 2017-220447 (JP 2017-220447 A) discloses a solid-state battery in which a side surface of a laminated battery is coated with resin. For example, Japanese Unexamined Patent Application Publication No. 2015-156366 (JP 2015-156366 A) discloses an electricity storage element in which a spacer including a restriction portion that abuts on a part of a current collector and that restricts movement in the longitudinal direction is disposed.

### SUMMARY

An active material of a solid-state battery repeats expansion and contraction with charge and discharge, and the volume variation of an active material layer may cause a crack (fracture) in a solid electrolyte layer.

The present disclosure has been made in view of the above circumstance.

The present disclosure has an object to provide a solid-state battery in which a crack is unlikely to occur in the solid electrolyte layer.

Specific means for achieving the above object includes the following aspects.
<1> A solid-state battery comprising:
   a laminated body in which a positive electrode current collector, a positive electrode active material layer, a solid electrolyte layer, a negative electrode active material layer, and a negative electrode current collector are laminated in this order;
   an outer package body that houses the laminated body in an interior; and
   a block body that contacts with a side surface of the positive electrode active material layer and/or a side surface of the negative electrode active material layer and that is fixed to the outer package body and/or the laminated body, wherein:
a Young's modulus of at least a portion of the block body is 50 GPa or higher, the portion of the block body contacting with the side surface of the positive electrode active material layer and/or the side surface of the negative electrode active material layer; and
both ends of the block body are away from the positive electrode current collector and the negative electrode current collector, in a lamination direction of the laminated body.
<2> In the solid-state battery according to <1>, the block body may be fixed to the outer package body.
<3> In the solid-state battery according to <1> or <2>, a bending strength of at least the portion of the block body that contacts with the side surface of the positive electrode active material layer and/or the side surface of the negative electrode active material layer may be 500 MPa or higher.
<4> In the solid-state battery according to any one of <1> to <3>,
the positive electrode active material layer may contain an S element,
the solid electrolyte layer may extend out relative to the positive electrode active material layer, in a direction orthogonal to the lamination direction of the laminated body, and
the block body may contact with the side surface of the positive electrode active material layer and one principal surface and a side surface of the solid electrolyte layer, and the block body may have an L-shape in a cross-section in the lamination direction of the laminated body.
<5> In the solid-state battery according to any one of <1> to <4>,
the block body may include a first block body that contacts with the side surface of the positive electrode active material layer, and a second block body that may contact with the first block body and the solid electrolyte layer, and
a Young's modulus of the second block body may be lower than a Young's modulus of the first block body.

The present disclosure provides a solid-state battery in which a crack is unlikely to occur in the solid electrolyte layer.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic sectional view showing an exemplary configuration of a solid-state battery in the present disclosure;

FIG. 2 is a schematic sectional view showing another exemplary configuration of the solid-state battery in the present disclosure;

FIG. 3 is a schematic sectional view showing another exemplary configuration of the solid-state battery in the present disclosure; and

FIG. 4 is a schematic sectional view showing another exemplary configuration of the solid-state battery in the present disclosure.

### DETAILED DESCRIPTION OF EMBODIMENTS

An embodiment of the present disclosure will be described below. The description and examples exemplify the embodiment, and do not limit the scope of the embodiment.

In the present disclosure, the term “step” includes not only an independent step, but also a step that cannot be clearly differentiated from another step, as long as the purpose of the step is achieved.

In the present disclosure, “A and/or B” is synonymous with “at least one of A and B”. That is, “A and/or B” means that only A may be adopted, only B may be adopted, or the combination of A and B may be adopted.

In the present disclosure, a numerical range shown using “-” shows a range that includes numerical values written before and after “-”, as a minimum value and a maximum value, respectively.

In numerical ranges described in a stepwise manner in the present disclosure, an upper limit value or lower limit value described in one numerical range may be replaced with an upper limit value or lower limit value in another numerical range described in a stepwise. Further, in a numerical range described in the present disclosure, an upper limit value or lower limit value in the numerical range may be replaced with a value shown in examples.

In the present disclosure, in the case where a plurality of kinds of substances that falls under a component exists in a composition, the amount of the component in the composition means the total amount of the plurality of kinds of substances that exists in the composition, unless otherwise noted.

### Solid-State Battery

A solid-state battery in the present disclosure includes a so-called all-solid-state battery in which a solid electrolyte is used as an electrolyte. In the solid-state battery in the present disclosure, the solid electrolyte may contain an electrolytic solution until an amount of less than 10 mass % of the whole electrolyte amount, and may be a composite solid electrolyte that contains an inorganic solid electrolyte and a polymer electrolyte.

The solid-state battery in the present disclosure includes: a laminated body in which a positive electrode current collector, a positive electrode active material layer, a solid electrolyte layer, a negative electrode active material layer, and a negative electrode current collector are laminated in this order; an outer package body that houses the laminated body in the interior; and a block body that contacts with a side surface of the positive electrode active material layer and/or a side surface of the negative electrode active material layer and that is fixed to the outer package body and/or the laminated body. The Young's modulus of at least a portion of the block body that contacts with the side surface of the positive electrode active material layer and/or the side surface of the negative electrode active material layer is 50 GPa or higher. Moreover, both ends of the block body are away from the positive electrode current collector and the negative electrode current collector, in a lamination direction of the laminated body.

In the present disclosure, the fixation between members means that the displacement between the members does not occur. For example, the fixation is realized by pressure welding between members, tightening of members, or adhesion with resin.

In the solid-state battery in the present disclosure, a crack is unlikely to occur in the solid electrolyte layer. The mechanism is speculated as follows.

Since the block body contacts with the side surface of the active material layer, there is no space that allows the active material layer to expand in the length direction. Moreover, since the block body is fixed to the outer package body and/or the laminated body and the Young's modulus of at least the portion that contacts with the side surface of the active material layer is 50 GPa or higher, the block body is a member that is hard to deform. Accordingly, the volume variation of the active material layer is restrained, and a crack is unlikely to occur in the solid electrolyte layer due to the volume variation of the active material layer.

In the solid-state battery in the present disclosure, since both ends of the block body are away from the positive electrode current collector and the negative electrode current collector in the lamination direction of the laminated body, the function and safety of the solid-state battery are assured. This is because the block body does not damage the current collectors and the block body does not interfere with the connection between the current collectors and electrode tabs. Further, the confining pressure that is given in the lamination direction of the laminated body by the outer package body and the like is surely given to the laminated body. Further, there are spaces that allow the internal pressure to be released, between the block body and the current collectors, and therefore, there is a low possibility that the battery explodes when the battery expands.

The Young's modulus of the block body is an index indicating that it is hard for the block body to deform. From the standpoint of the restraint of the expansion of the active material layer, the Young's modulus of at least the portion of the block body that contacts with the side surface of the positive electrode active material layer and/or the side surface of the negative electrode active material layer is 50 GPa or higher, preferably should be 70 GPa or higher, more preferably should be 100 GPa or higher, further preferably should be 150 GPa or higher, further preferably should be 200 GPa or higher, and further preferably should be 250 GPa or higher. The upper limit of the Young's modulus of the block body is not limited, and is 1000 GPa or lower, for example.

From the standpoint of the restraint of the expansion of the active material layer, the bending strength of at least the portion of the block body that contacts with the side surface of the positive electrode active material layer and/or the side surface of the negative electrode active material layer preferably should be 500 MPa or higher, more preferably should be 550 MPa or higher, and further preferably should be 600 MPa or higher.

The inventor performed a simulation for the solid-state battery. As a result, when the positive electrode active material layer was maximally elongated in a direction orthogonal to the lamination direction, a force equivalent to a bending strength of 500 MPa was loaded on the block body disposed so as to cover the outer circumference of the positive electrode active material layer. Accordingly, the block body preferably should have the above bending strength.

The upper limit of the bending strength of the block body is not limited, and is 1200 MPa or lower, for example.

The block body is a member composed of an insulating and electrochemically stable material. The block body may be a single member, or may be a member in which a plurality of members (for example, two or three members) is combined.

The measurement method for the Young's modulus and bending strength of the block body is shown as follows.

A test specimen is prepared using the same material as the real block body. The thickness direction of the test specimen is the thickness direction (the lamination direction of the laminated body) of the real block body. The length direction of the test specimen is the length direction (a direction orthogonal to the lamination direction of the laminated body) of the real block body. In the case where the block body is constituted by a plurality of members, the test specimen is made for each member.

In the case where the material is ceramics, the Young's modulus (GPa) of the block body is measured by performing a three-point bending test in accordance with JIS R1602 “Testing methods for elastic modulus of fine ceramics”. The bending strength (MPa) of the block body is measured by performing a three-point bending test in accordance with JIS R1601 “Testing method for flexural strength of the fine ceramics at room temperature”.

In the case where the material is resin, the Young's modulus (GPa) (tensile elasticity) is measured in accordance with JIS K7161 “Plastic-Determination of tensile properties”. The bending strength (MPa) is measured in accordance with JIS K7171 “Plastics-Determination of flexural properties”.

Each test is performed at a temperature of 23° C. and a relative humidity of 50%.

In an example of the embodiment of the solid-state battery in the present disclosure, the block body contacts with the side surface of the positive electrode active material layer, and the Young's modulus of at least the portion of the block body that contacts with the side surface of the positive electrode active material layer is 50 GPa or higher. The volume variation of the positive electrode active material layer easily occurs, and therefore, the block body is disposed so as to contact with the positive electrode active material layer.

In an example of the embodiment of the solid-state battery in the present disclosure, the block body is fixed to the outer package body. A force by which the outer package body tightens the block body and the laminated body acts as a reaction force against the expansion of the active material layer, so that it is possible to more effectively restrain the expansion of the active material layer compared to a case where the block body is fixed to the laminated body.

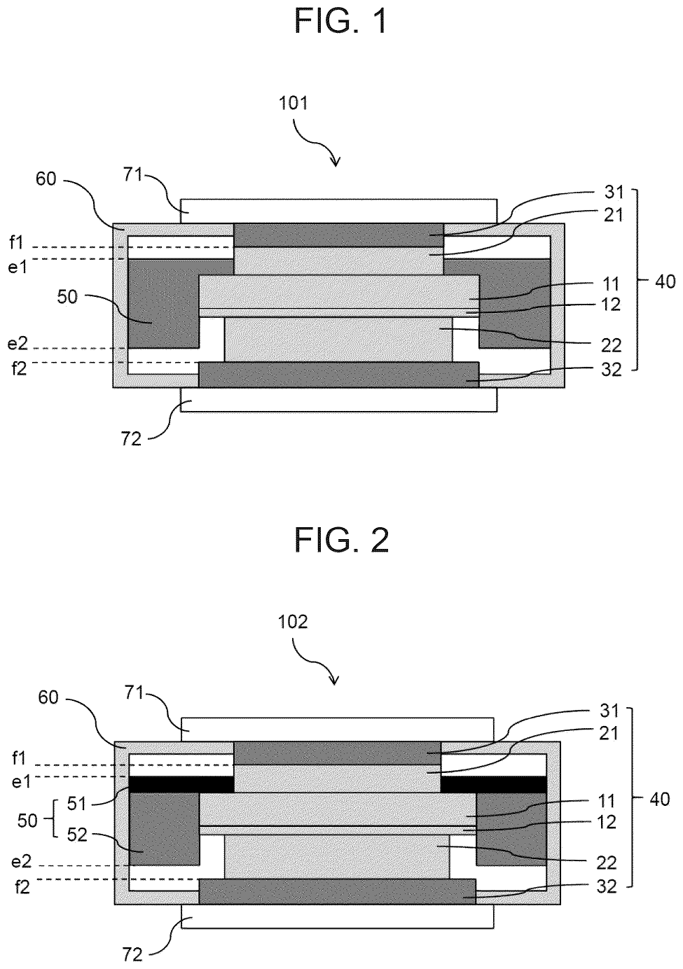

The configuration of the solid-state battery in the present disclosure will be described with reference to FIG. 1 to FIG. 4. Each of FIG. 1 to FIG. 4 is a schematic sectional view of an example of the embodiment of the solid-state battery, and shows a cross-section parallel to the lamination direction of the laminated body. Each of FIG. 1 to FIG. 4 is a schematic sectional view for describing positions of constituent elements, and structures of constituent elements are abstracted or simplified. Sizes of members in the drawings are conceptually shown, and relative relations among sizes of members are not limited to those in the drawings. In FIG. 1 to FIG. 4, constituent elements having the same function are denoted by identical reference characters, for description.

Each of solid-state batteries 101 to 104 includes a laminated body 40 in which a positive electrode current collector 31, a positive electrode active material layer 21, a solid electrolyte layer 11, a metal interface layer 12, a negative electrode active material layer 22, and a negative electrode current collector 32 are laminated in this order, a block body 50, an outer package body 60, a positive electrode tab 71, and a negative electrode tab 72. Each block body 50 of the solid-state batteries 102, 104 is constituted by a first block body 51 and a second block body 52. The metal interface layer 12 is a layer that is provided in an example of the embodiment, and may be excluded.

Each of the solid-state batteries 101 to 104 includes the laminated body 40 in which one positive electrode current collector 31, one positive electrode active material layer 21, one solid electrolyte layer 11, one negative electrode active material layer 22, and one negative electrode current collector 32 are laminated. The solid-state battery in the present disclosure is not limited to the above form. For example, the solid-state battery in the present disclosure may be a solid-state battery including a laminated body in which the positive electrode current collector 31, the positive electrode active material layer 21, the solid electrolyte layer 11, the negative electrode active material layer 22, the negative electrode current collector 32, the negative electrode active material layer 22, the solid electrolyte layer 11, the positive electrode active material layer 21, and the positive electrode current collector 31 are laminated in this order.

In each of the solid-state batteries 101 to 104, the outer package body 60 is welded to the block body 50 by pressure. Thereby, the block body 50 is fixed to the outer package body 60 and the laminated body 40.

In each of the solid-state batteries 101, 102, the solid electrolyte layer 11 extends out relative to the positive electrode active material layer 21, in the direction orthogonal to the lamination direction of the laminated body 40. The block body 50 contacts with the side surface of the positive electrode active material layer 21 and one principal surface and a side surface of the solid electrolyte layer 11. In each of the solid-state batteries 101, 102, the block body 50 has an L-shape in a cross-section in the lamination direction of the laminated body 40. The block body 50 in the embodiment has a stable disposition, and is relatively easily disposed in the battery interior, so that the expansion of the positive electrode active material layer 21 is more effectively restrained.

In each of the solid-state batteries 103, 104, the respective layers of the laminated body 40 have the same length in the direction orthogonal to the lamination direction of the laminated body 40, and the block body 50 contacts with the side surface of the positive electrode active material layer 21, the side surface of the solid electrolyte layer 11, and the side surface of the negative electrode active material layer 22. In each of the solid-state batteries 103, 104, the block body 50 has a rectangular shape in the cross-section in the lamination direction of the laminated body 40.

A line e1 and a line e2 show the position of an upper surface (a surface on the positive electrode current collector 31 side) of the block body 50 and the position of a lower surface (a surface on the negative electrode current collector 32 side) of the block body 50 in the lamination direction of the laminated body 40, respectively. A line f1 and a line f2 show the position of a lower surface (a surface on the block body 50 side) of the positive electrode current collector 31 and the position of an upper surface (a surface on the block body 50 side) of the negative electrode current collector 32 in the lamination direction of the laminated body 40, respectively.

The line e1 and the line f1 are away from each other, and the line e2 and the line f2 are away from each other. That is, both ends of the block body 50 are away from the positive electrode current collector 31 and the negative electrode current collector 32, in the lamination direction of the laminated body 40.

In each of the solid-state batteries 102, 104, the block body 50 includes the first block body 51 that contacts with the side surface of the positive electrode active material layer 21 and the second block body 52 that contacts with the first block body 51 and the solid electrolyte layer 11. The first block body 51 and the second block body 52 may be members composed of the same material, or may be members composed of different materials. Between the first block body 51 and the second block body 52, the Young's modulus and/or the bending strength may be the same, or may be different.

From the standpoint of the restraint of the expansion of the positive electrode active material layer 21, the Young's modulus of the first block body 51 is 50 GPa or higher, preferably should be 70 GPa or higher, more preferably should be 100 GPa or higher, further preferably should be 150 GPa or higher, further preferably should be 200 GPa or higher, and further preferably should be 250 GPa or higher. The bending strength of the first block body 51 preferably should be 500 MPa or higher, more preferably should be 550 MPa or higher, and further preferably should be 600 MPa or higher. Examples of the first block body 51 include a member composed of ceramics (including fine ceramics), a member composed of artificial crystal, a member composed of quartz glass, and a member composed of borosilicate glass.

From the standpoint of the prevention of the damage of the outer package body 60 and the laminated body 40, the second block body 52 preferably should be a member that is not excessively rigid. Accordingly, the Young's modulus of the second block body 52 preferably should be lower than the Young's modulus of the first block body 51, preferably should be lower than 50 GPa, more preferably should be 30 GPa or lower, and further preferably should be 10 GPa or lower. The bending strength of the second block body 52 preferably should be 300 MPa or lower, more preferably should be 200 MPa or lower, and further preferably should be 150 MPa or lower. Examples of the second block body include a member composed of resin.

The respective layers constituting the laminated body and the outer package body will be described below in detail. In the following description, reference characters are omitted.

### Positive Electrode Current Collector

The shape of the positive electrode current collector is a foil shape or a mesh shape, for example. Examples of the material of the positive electrode current collector include stainless steel, aluminum, nickel, iron, titanium, and carbon. Preferably, the positive electrode current collector should be an aluminum alloy foil or an aluminum foil.

### Positive Electrode Active Material Layer

The positive electrode active material layer contains a positive electrode active material. The positive electrode active material layer may contain at least one of a positive electrode solid electrolyte, a conduction aid, and a binder, as necessary. As the positive electrode active material layer, all known positive electrode active material layers can be applied.

Examples of the embodiment of the positive electrode active material layer include a layer that contains a positive electrode active material including an S element, a sulfur-containing compound including a P element and the S element, and a conduction aid and that does not contain an Li element substantially. To the embodiment, a positive electrode composite material described in Japanese Unexamined Patent Application Publication No. 2019-212615 (JP 2019-212615 A) can be applied.

In the above positive electrode active material layer, the irreversible capacity is small, and it is hard for the capacity to decrease. By applying the above positive electrode active material layer to the solid-state battery in the present disclosure, it is possible to further enhance the reliability of the solid-state battery.

Preferably, the S element should be S₈ sulfur that is elemental sulfur. The S₈ sulfur may have any crystal shape of α-sulfur, β-sulfur, and γ-sulfur.

Preferably, the sulfur-containing compound should contain a PS₄ structure that is an ortho-structure of the P element. The sulfur-containing compound may contain an ortho-structure of an M element (M is Ge, Sn, Si, B, or Al, for example). Examples of the ortho-structure of the M element include a GeS₄ structure, a SnS₄ structure, a SiS₄ structure, a BS₃ structure, and an AlS₃ structure. The sulfur-containing compound may contain a sulfide (for example, P₂S₅) of the P element.

Examples of the conduction aid include a carbon material, a metal material, and an electrically conductive polymeric material. Examples of the carbon material include carbon black (for example, acetylene black, furnace black, and Ketjen black), fibrous carbon (for example, vapor-grown carbon fiber, carbon nanotube, and carbon nanofiber), plumbago, and carbon fluoride. Examples of the metal material include metal powder (for example, aluminum powder), electrically conductive whisker (for example, zinc oxide and potassium titanate), and an electrically conductive metal oxides (for example, titanic oxide). Examples of the electrically conductive polymeric material include polyaniline, polypyrrole, and polythiophene. As the conduction aid, only one kind may be used alone, or two or more kinds may be mixed and used.

Examples of the binder include vinyl halide resin, rubbers, and polyolefin resin. Examples of other components include a solid oxide electrolyte, a solid halide electrolyte, a thickener, an interfacial, a dispersant, a wetting agent, an antifoam agent, and a thinner.

### Negative Electrode Current Collector

The shape of the negative electrode current collector is a foil shape or a mesh shape, for example. Examples of the material of the negative electrode current collector include stainless steel, aluminum, copper, nickel, iron, titanium, and carbon. Preferably, the negative electrode current collector should be a copper foil or a nickel foil.

### Negative Electrode Active Material Layer

The negative electrode active material layer contains a negative electrode active material. The negative electrode active material layer may contain at least one of a negative electrode solid electrolyte, a conduction aid, and a binder, as necessary. As the negative electrode active material layer, all known negative electrode active material layers can be applied.

Examples of the negative active material include a Li active material such as a metal lithium, a carbon active material such as graphite, an oxide active material such as lithium titanate, and a Si active material such as elemental Si.

Examples of the embodiment of the negative electrode active material layer include a metal Li foil and a Li—X alloy foil (X is Mg, Ag, In, Sn, Si, Ga, Au, or Pt, for example). For example, the ratio of X is 1 mass %-20 mass %.

### Solid Electrolyte Layer

The solid electrolyte layer contains a solid electrolyte. The solid electrolyte may contain an electrolytic solution until an amount of less than 10 mass % of the whole electrolyte amount. The solid electrolyte may be a composite solid electrolyte that contains an inorganic solid electrolyte and a polymer electrolyte.

Preferably, the solid electrolyte should contain one selected from the group consisting of a solid sulfide electrolyte, a solid oxide electrolyte, and a solid halide electrolyte.

The solid sulfide electrolyte contains sulfur(S) as a main component of an anion element, and preferably should further contain the Li element and an A element, for example. The A element is at least one kind selected from the group consisting of P, As, Sb, Si, Ge, Sn, B, Al, Ga, and In.

The solid oxide electrolyte contains oxygen (O) as a main component of an anion element, and may further contain the Li element and a Q element, for example. The Q element is at least one kind selected from the group consisting of Nb, B, Al, Si, P, Ti, Zr, Mo, W, and S.

Preferably, the solid halide electrolyte should be a solid electrolyte containing Li, M, and X (M represents at least one of Ti, Al, and Y, and X represents F, Cl, or Br).

The solid electrolyte layer may contain a binder, or may contain no binder. Examples of the binder that can be contained in the solid electrolyte layer include vinyl halide resin, rubbers, and polyolefin resin. Examples of the vinyl halide resin include polyvinylidene fluoride (PVdF) and a copolymer (PVdF-HFP) of polyvinylidene fluoride and hexafluoropropylene. Examples of the polyolefin resin include butadiene rubber (BR), acylate-butadiene rubber (ABR), styrene-butadiene rubber (SBR), acrylonitrile-butadiene rubber (NBR), and butyl rubber (isobutylene-isoprene rubber). Examples of the polyolefin resin include polyethylene and polypropylene. The binder may be a diene rubber that includes a double bond in a main chain, and for example, may be a butadiene rubber in which butadiene is contained at a ratio of 30 mol % or more of the whole amount.

### Metal Interface Layer

The metal interface layer may be between the solid electrolyte layer and the negative electrode active material layer. For example, the metal interface layer is a metal deposited film with In, Sn, an In—Sn alloy, or the like.

### Outer Package Body

Examples of the outer package body include an aluminum laminate film pack and a metal can.

### Production Method for Solid-State Battery

For example, the solid-state battery in the present disclosure is produced by first to third steps described below.

The first step is a step of producing the laminated body by laminating the positive electrode current collector, the positive electrode active material layer, the solid electrode layer, the negative electrode active material layer, and the negative electrode current collector in this order. The metal interface layer may be laminated between the solid electrolyte layer and the negative electrode active material layer.

The second step is a step of disposing the block body around the laminated body.

The third step is a step of disposing the positive electrode tab and the negative electrode tab, performing the putting in the outer package body, and performing vacuum lock.

The shape and use purpose of the solid-state battery in the present disclosure are not limited. For example, the solid-state battery in the present disclosure can be applied to a hybrid electric vehicle (HEV), a plug-in hybrid electric vehicle (PHEV), and a battery electric vehicle (BEV).

The solid-state battery in the present disclosure will be more specifically described below with examples. Materials, dimensions, combinations, and others shown in the following examples can be appropriately altered without departing from the spirit of the present disclosure. Accordingly, the solid-state battery in the present disclosure should not be interpreted in a limited way, by specific examples shown below.

In the following description, syntheses, treatments, productions, and others were performed at room temperature (25° C.±3° C.), unless otherwise noted.

### Production of Experiment Cell

### Configuration of Cell

Laminated body: roughened Al foil/S—P₂S₅—C composite material layer/solid sulfide electrolyte/Sn layer/Li-10 mass % Mg alloy foil/roughened Ni foil
Block body: The material and the dimensions will be described later in Type 1 to Type 4
Positive electrode tab: Al foil
Negative electrode tab: Ni foil
Laminate film: aluminum laminate film

### Production of Positive Electrode

S (80° C. vacuum-dried product), P₂S₅, and single-walled CNT (120° C. vacuum-dried product) were mixed in a mortar at a mass ratio of 42:35:23. In each ball mill pot, 1.7 g of the mixture and 80 g of zirconia balls having a diameter of 4 mm were put, and planetary ball milling was performed at 400 rpm for a total of 36 hours. After the ball mill mixing, the classification was performed by a dry method using a 38-μm sieve, so that a positive electrode sulfur composite material was obtained. Using mesitylene as a solvent, a positive electrode slurry was produced such that the mass ratio between the positive electrode sulfur composite material and a binder was 99.7:0.3. The roughened Al foil was coated with the positive electrode slurry at a coating gap of 220 μm. Thereafter, provisional drying was performed at 50° C., and real drying was performed at 100° C. for 30 minutes, so that a positive electrode (a positive electrode current collector and a positive electrode active material layer) was obtained. The positive electrode was punched such that a circular shape having a predetermined diameter was obtained.

Production of Solid Electrolyte layer

Using heptane as a solvent, a solid electrolyte slurry was produced such that the mass ratio between the solid electrolyte (median diameter: 0.5 μm) and a binder was 90.9:9.1. A mold release film is coated with the solid electrolyte slurry at a coating gap of 450 μm. Thereafter, provisional drying was performed at room temperature for 3 hours, and real drying was performed at 165° C. for 1 hour, so that a solid electrolyte layer was obtained. The solid electrolyte layer with the mold release film was punched such that a circular shape having a predetermined diameter was obtained. Two coated surfaces were overlapped so as to face each other, and were pressed at room temperature at 6 t. After the pressing, the mold release films were released, so that an independent solid electrolyte layer was obtained. Next, a metal interface layer (Sn layer, thickness: 0.1 μm) was formed as a film on one surface of the independent solid electrolyte layer, by sputtering.

### Production of Negative Electrode

The Li-10 mass % Mg alloy foil (thickness: 100 μm) was punched such that a circular shape having a predetermined diameter was obtained. The roughened Ni foil was punched such that a circular shape having a predetermined diameter was obtained. The adhesion between the Li-10 mass % Mg alloy foil and the roughened Ni foil was performed at 0.1 t, so that a negative electrode (a negative electrode current collector and a negative electrode active material layer) was obtained.

### Production of Laminate Cell

The negative electrode, the independent solid electrolyte layer, and the positive electrode were overlapped in this order, so that a laminated body was formed. On this occasion, a block body was disposed around the laminated body. Next, a positive electrode tab and a negative electrode tab were disposed, and vacuum lock was performed in a laminate film. The isotropic pressing of the locked cell was performed at 300 MPa by cold isostatic pressing (CIP), so that a laminate cell was obtained.

By the above steps, experiment cells in Type 1 to Type 4 were produced. The dimensions of each Type are shown as follows.

### Type 1

Type 1 has the form shown in the schematic view in FIG. 2.

The diameter of each layer is the diameter of the circle after the punching. The layer thickness of each layer is the thickness of the layer at the time of the production of the layer.
Positive electrode current collector: a diameter of 11.28 mm
Positive electrode active material layer: a diameter of 11.28 mm, a layer thickness of 60 μm
Solid electrolyte layer: a diameter of 14.50 mm, a layer thickness of 75 μm
Metal interface layer: a diameter of 14.50 mm, a layer thickness of 0.1 μm
Negative electrode active material layer: a diameter of 13.00 mm, a layer thickness of 100 μm
Negative electrode current collector: a diameter of 14.50 mm
First block body: a member in which a hole having an inner diameter of 11.28 mm is provided on a rectangular plate having a size of 30 mm×30 mm, a thickness of 40 μm; The material is PEEK resin, high-strength alumina, or sapphire.
Second block body: a member in which a hole having an inner diameter of 15.10 mm is provided on a rectangular plate having a size of 30 mm×30 mm, a thickness of 135 μm; The material is the same as the material of the first block body (the inner diameter of the second block body was set so as to be slightly larger than the diameter of 14.50 mm in consideration of the elongation of the solid electrolyte layer in the direction orthogonal to the lamination direction at the time of the production of the cell).

The first block body was disposed so as to contact with a lower portion (a side close to the solid electrolyte layer) of the side surface of the positive electrode active material layer and one principal surface of the solid electrolyte layer. The second block body was disposed so as to contact with a lower surface (a surface on the solid electrolyte layer side) of the first block body and the side surface of the solid electrolyte layer.

### Type 2

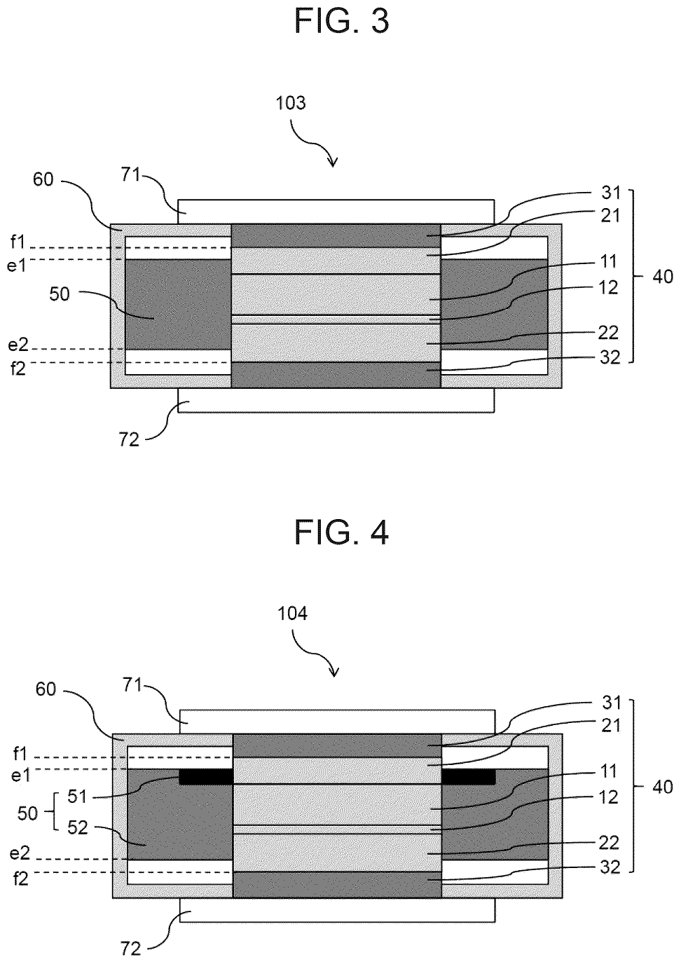

Type 2 has the form shown in the schematic view in FIG. 3.

The diameter of each layer is the diameter of the circle after the punching. The layer thickness of each layer is the thickness of the layer at the time of the production of the layer.
Positive electrode current collector: a diameter of 11.28 mm
Positive electrode active material layer: a diameter of 11.28 mm, a layer thickness of 60 μm
Solid electrolyte layer: a diameter of 11.28 mm, a layer thickness of 75 μm
Metal interface layer: a diameter of 11.28 mm, a layer thickness of 0.1 μm
Negative electrode active material layer: a diameter of 11.28 mm, a layer thickness of 100 μm
Negative electrode current collector: a diameter of 11.28 mm
Block body: a member in which a hole having an inner diameter of 11.28 mm is provided on a rectangular plate having a size of 30 mm×30 mm, a thickness of 210 μm; The material is PEEK resin, high-strength alumina, or sapphire.

The block body was disposed so as to contact with a lower portion (a side close to the solid electrolyte layer) of the side surface of the positive electrode active material layer, the side surface of the solid electrolyte layer, and an upper portion (a side close to the solid electrolyte layer) of the side surface of the negative electrode active material layer.

### Type 3

Type 3 has the form shown in the schematic view in FIG. 2. An experiment cell was produced similarly to the experiment cell in Type 1, except that the material of the second block body was PEEK resin as a whole.

### Type 4

Type 4 has the form shown in the schematic view in FIG. 4. An experiment cell was produced similarly to the production of the experiment cell in Type 2, except that the block body was altered as described below.
First block body: a member in which a hole having an inner diameter of 11.28 mm is provided on a rectangular plate having a size of 20 mm×20 mm, a thickness of 40 μm; The material is PEEK resin, high-strength alumina, or sapphire
Second block body: a member in which a hole having an inner diameter of 11.28 mm is provided on a rectangular plate having a size of 30 mm×30 mm, a thickness of 210 μm; A stage portion (inside dimension: 20 mm×20 mm, height: 40 μm) into which the first block body is fit is provided at an upper portion of the internal surface. The material was PEEK resin.

The first block body was fit into the stage portion of the second block body, and the block body was disposed so as to contact with a lower portion (a side close to the solid electrolyte layer) of the side surface of the positive electrode active material layer, the side surface of the solid electrolyte layer, and an upper portion (a side close to the solid electrolyte layer) of the side surface of the negative electrode active material layer.

### Performance Evaluation

### Initial Cycle Test

A constant-current density of 0.584 mA/cm² (equivalent to 0.1 C in the case of 1 C=5.84 mA/cm²) was applied to the cell in a cutoff voltage range of 3.1 V-1.2 V, and an initial cycle test was performed at 60° C. It was confirmed whether there was a crack in the solid electrolyte layer at the time of the initial expansion of the positive electrode.

Results for Type 1 and Type 2 are shown in Table 1, and results for Type 3 and Type 4 are shown in Table 2.

TABLE 1

| | Block Body | | | | Crack in |
|---|---|---|---|---|---|
| | | Young's | Bending | Cell | Solid |
| | | Modulus | Strength | Config- | Electrolyte |
| | Material | [GPa] | [MPa] | uration | Layer |
| Comparative | PEEK resin | 3.4 | 140 | Type 1 | Present |
| Example 1 | | | | Type 2 | Present |
| Example 1 | High-strength | 300 | 740 | Type 1 | Absent |
| | alumina | | | Type 2 | Absent |
| Example 2 | Sapphire | 470 | 670 | Type 1 | Absent |
| | | | | Type 2 | Absent |

TABLE 2

| | First Block Body | | | | | Crack in |
|---|---|---|---|---|---|---|
| | | Young's | Bending | Second | | Solid |
| | | Modulus | Strength | Block Body | Cell | Electrolyte |
| | Material | [GPa] | [MPa] | Material | Configuration | Layer |
| Comparative | PEEK resin | 3.4 | 140 | PEEK resin | Type 3 | Present |
| Example 11 | | | | | Type 4 | Present |
| Example 11 | High-strength | 300 | 740 | PEEK resin | Type 3 | Absent |
| | alumina | | | | Type 4 | Absent |
| Example 12 | Sapphire | 470 | 670 | PEEK resin | Type 3 | Absent |
| | | | | | Type 4 | Absent |

What is claimed is:

1. A solid-state battery comprising:
a laminated body in which a positive electrode current collector, a positive electrode active material layer, a solid electrolyte layer, a negative electrode active material layer, and a negative electrode current collector are laminated in this order;
an outer package body that houses the laminated body in an interior; and
a block body that contacts with a side surface of the positive electrode active material layer and/or a side surface of the negative electrode active material layer and that is fixed to the outer package body and/or the laminated body, wherein:
a Young's modulus of at least a portion of the block body is 50 GPa or higher, the portion of the block body contacting with the side surface of the positive electrode active material layer and/or the side surface of the negative electrode active material layer; and
both ends of the block body are away from the positive electrode current collector and the negative electrode current collector, in a lamination direction of the laminated body.

2. The solid-state battery according to claim 1, wherein the block body is fixed to the outer package body.

3. The solid-state battery according to claim 1, wherein a bending strength of at least the portion of the block body that contacts with the side surface of the positive electrode active material layer and/or the side surface of the negative electrode active material layer is 500 MPa or higher.

4. The solid-state battery according to claim 1, wherein:
the positive electrode active material layer contains an S element;
the solid electrolyte layer extends out relative to the positive electrode active material layer, in a direction orthogonal to the lamination direction of the laminated body; and
the block body contacts with the side surface of the positive electrode active material layer and one principal surface and a side surface of the solid electrolyte layer, and the block body has an L-shape in a cross-section in the lamination direction of the laminated body.

5. The solid-state battery according to claim 1, wherein:
the block body includes a first block body that contacts with the side surface of the positive electrode active material layer, and a second block body that contacts with the first block body and the solid electrolyte layer; and
a Young's modulus of the second block body is lower than a Young's modulus of the first block body.
